(19) United States
(12) Patent Application Publication
(10) Pub. No.: US 2025/0147487 A1
(43) Pub. Date: May 8, 2025

(54) INFORMATION PROCESSING METHOD, PROCESSING SYSTEM, AND PROCESSING APPARATUS FOR A HOME APPLIANCE

(71) Applicant: LG ELECTRONICS INC., Seoul (KR)

(72) Inventors: Hyunsun YOO, Seoul (KR); Minjeong KANG, Seoul (KR); Kyungin OH, Seoul (KR); Sukhyun LIM, Seoul (KR); Hyeran KIM, Seoul (KR)

(73) Assignee: LG ELECTRONICS INC., Seoul (KR)

(21) Appl. No.: 18/725,637

(22) PCT Filed: Sep. 7, 2023
(86) PCT No.: PCT/KR2023/013417

§ 371 Date: Jan. 21, 2025

(30) Foreign Application Priority Data
Oct. 11, 2022 (KR) 10-2022-0129588

(51) Int. Cl. G05B 19/418; H04L 12/28

(52) U.S. Cl. CPC G05B 19/418; H04L 12/2816; G05B 2219/2642

(57) ABSTRACT

An information processing system for a home appliance according to the present invention may include: at least one home appliance; a terminal configured to process information of the at least one home appliance; an individual service area configured to provide an individual service; and an information processing apparatus connected to the terminal and the at least one home appliance through a network and configured to provide an application service using the individual service. The system may identify user needs for the individual service and provide a corresponding application service.

### TECHNICAL FIELD

The present invention relates to an information processing method for home appliances, an information processing system for home appliances, and an information processing apparatus for home appliances.

### BACKGROUND ART

Home appliances mainly refer to devices installed in the user's home to help the user with housework. Home appliances may be fixed in the user's home to operate according to user's commands. The user may schedule and operate the home appliances. For example, if plaining to come back home at 5 o'clock, it makes a reservation in advance to allow an air conditioner to operate at 4:30 o'clock. According to this example, a user who return home may enjoy a clean indoor environment.

Home appliances may access the Internet through a wired or wireless communication network, such as Wi-Fi. The user may collect information about operations of the home appliances through the Internet. The user may transmit control commands to the home appliances through the Internet. As described above various services are possible because the user and the home appliances in remote locations communicate with each other. For example, even if an operation of a home appliance has not been reserved, the home appliance may be reserved or operated in real time through the terminal. As a detailed example, even if you do not reserve the operation of the air conditioner when going to work, the user may operate the air conditioner in advance through the terminal when leaving work.

Due to the above technologies, the user may use the home appliances more conveniently. Although it was expected that these various home appliance reservation operations could greatly change the daily life, the reality is that the home appliances are not being utilized as much as expected. The inventor thought deeply about this problem and came up with the present invention.

The inventor found that there was a major problem in that, even if a user made a scheduled operation of a home appliance, it did not operate in a desired operating state. For example, the present applicant has proposed a technology that is disclosed in KR102157239B1, titled ‘Air purifier and method for providing recommendation information corresponding to schedule based on artificial intelligence’. This technology registers the user's schedule in the air purifier before outgoing and proposes additional information in response to the schedule. However, the above techniques are limited to providing piecemeal information. In addition, since the predicted information on outdoor environments is future information, there is a problem of low accuracy. Thus, there is a problem in that users may not trust the recommended information to reduce its usability.

The inventor found that there are many cases in which the operation of the reserved home appliance does not operate in a situation desired by the inventor. For example, the user may feel that the air quality is poor and activate the air purifier. However, the indoor space may be in an environment that requires ventilation due to volatile organic compounds that is not filtered. In this environment, the air purifier may not filter the organic compounds, and thus, power is wasted, and consumers are continuously exposed to a harmful environment.

In many other cases, automatic operations of the home appliances may cause various problems such as excessive energy waste, unnecessary damage, and undesirable conditions.

### DISCLOSURE OF THE INVENTION

### Technical Problem

The present invention proposes an information processing method for a home appliance, an information processing system for a home appliance, and an information processing apparatus for a home appliance, which are capable of responding to a user's schedule.

The present invention proposes an information processing method for a home appliance, an information processing system for a home appliance, and an information processing apparatus for a home appliance, in which an home appliance optimally operates even when a user in not aware of the home appliance.

The present invention proposes an information processing method for a home appliance, an information processing system for a home appliance, and an information processing apparatus for a home appliance, which a operation of a home appliance is further reservation activated.

For further objects of the present invention, refer to the contents disclosed in the specific details for carrying out the invention.

### Technical Solution

An information processing system for a home appliance according to the present invention may include: at least one home appliance; a terminal configured to process information of the at least one home appliance; an individual service area configured to provide an individual service; and an information processing apparatus connected to the terminal and the at least one home appliance through a network and configured to provide an application service using the individual service. The system may identify user needs for the individual service and provide a corresponding application service.

Optionally, the information processing apparatus may be configured to: receive basic information of a user using the at least one home appliance; and confirm that an indoor environment is environmental information requiring air purification from the basic information by using the individual service.

Optionally, the information processing apparatus may be configured to confirm that an indoor environment is environmental information that requires air purification using the individual service.

Optionally, the information processing may be configured to confirm a first state of a first home appliance of the at least one home appliance; and allow the first home appliance to be maintained in first state in response to the environmental information. Accordingly, the user may conveniently use the home appliance.

Optionally, the information processing apparatus may be configured to: confirm a first state of a first home appliance of the at least one home appliance; and change a state of a second home appliance of the at least one home appliance in response to the environmental information, or transmit a message to the user in response to the environmental information. Accordingly, the first and second home appliances may operate cooperatively with each other.

Optionally, the basic information may include a user behavior. An application service may be received using action in the morning without being aware of it. Optionally, the basic information may include a user's voice. The user may actively request the service. Optionally, the basic information may include detection information from an air quality sensor. The application service that needs at a specific time may be received without any instruction from the user.

Optionally, the first home appliance may be an air purifier, the first state may be a state in which the air purifier is operating or stopped, and the second home appliance may be a ventilation device. Accordingly, the indoor air purification may be actively carried out.

Optionally, changing of the state of the ventilation device may include changing the ventilation device to operate. Accordingly, the active ventilation may be performed.

Optionally, after the state of the second home appliance is changed, the state of the first home appliance may be stopped. Accordingly, damage of the first home appliance due to the operation of the second home appliance may be prevented.

Optionally, the first home appliance may be an air purifier, and the second home appliance may be a ventilation device. The operations of the two home appliances may be performed in a desired sequence without user instructions.

Optionally, the state of the ventilation device may be changed to operate, the air purifier may be stopped, or the message may be a message to start ventilation. As a result, the users may confirm the information.

Optionally, the first state may be a state in which the air purifier is stopped in operation, and the user's basic information may be an operation start signal of the air purifier. Optionally, the first home appliance may be the air purifier. Optionally, the first home appliance may be the ventilation device.

Optionally, the message may be a message to stop the ventilation. Accordingly, the indoor environment may be adjusted by actively comparing the outdoor and indoor environments.

An information processing apparatus according to the present invention may include an I/O module that communicates with at least one external home appliance; a memory configured to store outdoor environment information; and an operation determination module configured to confirm that air purification is necessary by comparing the indoor environment information in which a user using the at least one home appliance resides with the outdoor environment information.

Optionally, the operation determination module may be configured to maintain a first home appliance in its current state, change a state of a second home appliance, or transmit a message for air purification to the user.

Optionally, after the state of the second home appliance is changed, the state of the first home appliance may be changed from first state to a second state. Accordingly, a cooperative operation the home appliances may become closer. Mutual conflict between the home appliances may be prevented.

An information processing method according to the present invention may include: receiving user's basic information; allowing an information processing apparatus to identify air purification information from the basic information using an individual service in an individual service area; comparing indoor environmental information with outdoor environmental information; and perform a first process of operating a ventilation device in a ventilation state after maintaining a state of an air purifier to purify air. Optionally, the information processing method may include a second process of operating the air purifier in a state in which the ventilation device is stopped to purify the air. The first process and the second process may be determined separately.

Optionally, the basic information may be the user's actions during a certain time period. A convenient and clean indoor environment may be maintained even when the user is not aware of it.

Optionally, when the ventilation device operates in a ventilation state, the air purifier may be stopped. Thus, it may prevent the air purifier from purifying external air.

Optionally, after the ventilation device performs the ventilation, the ventilation device may be switched to the stopped state, and the air purifier may operate. Accordingly, the clean indoor environment may be maintained regardless of the type of hazardous substances.

Optionally, the indoor environment information and the outdoor environment information may include a concentration of carbon dioxide.

Optionally, the individual service may operate by an AI server. Accordingly, the basic information may be determined more accurately.

Optionally, the first process or the second process may be performed without notifying the user. Accordingly, a good indoor environment may be provided to users without the user's awareness or actions.

An information processing method according to the present invention may include: receiving user's basic information; allowing an information processing apparatus to identify air purification information from the basic information using an individual service in an individual service area; and operating a ventilation device in a ventilation state after maintaining a state of an air purifier to purify air. Accordingly, poor indoor air quality in the morning may be improved.

Optionally, the information processing method may include transmitting a message to the user. A message requesting the ventilation may be used to let the user know the need for the ventilation.

Optionally, when the ventilation device is in a ventilation state, the air purifier may be stopped. Accordingly, useless operation of the air purifier may be prevented.

Optionally, after the ventilation device operates in the ventilation state for a predetermined period of time, the air purifier may operate again. Accordingly, various harmful substances may be removed to comfortably maintain the indoor environment.

### Advantageous Effects

According to the present invention, the user may change the home appliance reservation operation in response to his/her unconscious behavior, the daily behavior, and the schedule. Accordingly, there may be the advantage in that the optimal operation of the home appliance is achieved on its own even when the user is not aware of the reservation operation.

According to the present invention, even if there is no scheduled operation of the home appliance, the home appliance may operate in the energy-saving environment that is desirable for the user's health.

According to the present invention, there may be the advantage that the user's life is enriched by artificial intelligence tasks that match the operation of the home appliance and the user's schedule.

According to the present invention, the reservation operation of the home appliance may be further activated to provide the advantage of making the user's life more convenient.

According to the present invention, at least two home appliances may perform the cooperative operation. Accordingly, the optimal indoor environment may be established.

According to the present invention, it is possible to actively guide or operate the operating conditions of the home appliances that are advantageous to the user even without the user's knowledge.

For further effects of the present invention, refer to the contents disclosed in the specific details for carrying out the invention.

### BRIEF DESCRIPTION OF THE DRAWINGS

FIG. 1 is a view illustrating an information processing system for a home appliance according to an embodiment.

FIG. 2 is a view illustrating a configuration of the information processing system for the home appliance, which shows a cloud system in more detail.

FIG. 3 is a view for explaining an information processing apparatus for a home appliance according to an embodiment.

FIG. 4 is a view for explaining an example of providing a learning model.

FIG. 5 is a view illustrating a flow of an information processing method according to an embodiment.

FIG. 6 is a view illustrating an interface in the information processing method according to an embodiment.

FIG. 7 is a flowchart of the information processing method for the home appliance according to an embodiment.

FIG. 8 is a flowchart of the information processing method for the home appliance according to an embodiment.

FIG. 9 is a flowchart of the information processing method for the home appliance according to an embodiment.

FIG. 10 is a graph illustrating an indoor carbon dioxide concentration.

### MODE FOR CARRYING OUT THE INVENTION

Hereinafter, specific embodiments will be described in detail with reference to the accompanying drawings. The invention may, however, be embodied in many different forms and should not be construed as being limited to the embodiments set forth herein, and a person of ordinary skill in the art, who understands the spirit of the present invention, may readily implement other embodiments included within the scope of the same concept by adding, changing, deleting, and adding components; rather, it will be understood that they are also included within the scope of the present invention. The present invention may have many embodiments in which the idea is implemented, and in each embodiment, any portion may be replaced with a corresponding portion or a portion having a related action according to another embodiment. The present invention may be any one of the examples presented below or a combination of two or more examples.

In this application, the information processing method, the information processing system, and the information processing apparatus examine the same inventive idea from different aspects. Any shortcomings in one embodiment may be supplemented by explanation of other embodiments. Any portion of one embodiment may be expanded or changed according to the description of other embodiments.

In the description of the drawings, identical or similar components are given the same reference numbers regardless of reference numerals, and duplicated descriptions thereof may be omitted.

The suffixes “module” and “unit” for components used in the description below are assigned or mixed in consideration of easiness in writing the specification and do not have distinctive meanings or roles by themselves.

In describing the embodiments disclosed in this application, detailed descriptions related to well-known functions or configurations will be ruled out in order not to unnecessarily obscure subject matters of the present invention.

However, this does not limit the present invention within specific embodiments and it should be understood that the present invention covers all the modifications, equivalents, and replacements within the idea and technical scope of the present invention.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

The terms of a singular form may include plural forms unless referred to the contrary.

In this application, the terms “comprises” or “having” are intended to indicate that there is a feature, number, step, operation, component, part, or combination thereof described in the specification, and one or more other features. It is to be understood that the present invention does not exclude the possibility of the presence or the addition of numbers, steps, operations, components, components, or a combination thereof.

In this application, home appliances may also include the same type of devices, but be used for commercial, public, and other purposes other than at home.

In this application, a service may include a processor that provides processing results for requests for a specific purpose. Here, the service may be an abbreviation for a service module. Here, the processor may include hardware, software running on specific hardware, or software running on general-purpose hardware. The service may refer to certain data.

In the description of the method of the present application, even if the first process (e.g., S1) is performed before the second process (e.g., S2), the first process does not necessarily precede the second process. According to contents of the embodiment, the processes may be changed.

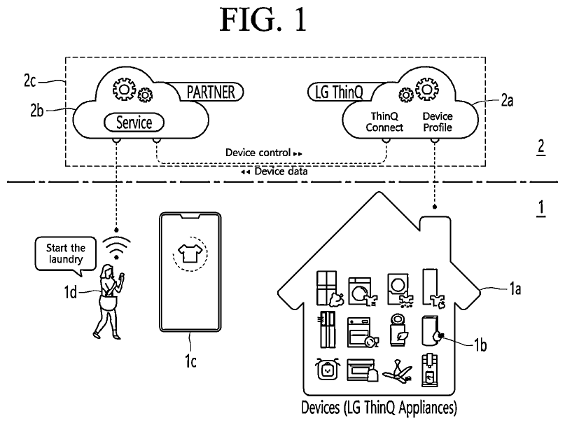

FIG. 1 is a view illustrating an information processing system for a home appliance according to an embodiment.

Referring to FIG. 1, an information processing system for a home appliance may include a user area 1 and an operator area 2. The user area 1 may be a dominant area for a user who use home appliances. The operator area 2 may be a control area of an operator who provides the home appliances, operates the system, or provides a services.

The user area 1 may include a building 1a. The home appliances 1b may be placed in the building 1a. The building 1a may be connected to any structure to which a network is connected. The home appliances may include home 1b appliances such as massagers, water purifiers, vacuum cleaners, clothes care machines, refrigerators, washing machines, air purifiers, cookers, and air conditioners. The home appliances are not limited thereto, and may include various devices such as automobiles, plant cultivators, and pumps. The user area 1 may include a terminal 1c. The user 1d may perform communication using the terminal 1c. The terminal 1c may be linked to any structure to which a network is connected. The terminal may be compatible with the home appliance. At least one terminal may be provided. The terminal may include at least two for direct or indirect interaction between the terminals.

The operator area 2 may include a server 2c. The server 2c may perform at least some functions of the information processing apparatus according to the present invention. The server 2c may be an operation server that operates the home appliance. In this case, the operation information of the home appliance may be obtained. The server 2c may be a communication server that communicates with the terminal. The server 2c may be a server of a manufacturer of the home appliance. The server 2c may be a server of an operator of the home appliance. In this case, management of the home appliance may be performed. For example, a quality control may be performed. The server 2c may include a first server 2a that communicates with the home appliance 1b. The server 2c may include a second server 2b that communicates with the terminal 1c. The first and second servers 2a and 2b may communicate with each other. The first and second servers 2a and 2b may not be separated, but may be configured as a single device. The first and second servers 2a and 2b may be implemented by at least one cloud system.

The first server 2a may receive usage information including an operation state of the home appliance 1b. For example, usage information such as an operation time, an operation mode, and a failure state of the home appliance 1b may be received. The first server 2a may control an operation of the home appliance. The second server 2b may transmit the operation state of the home appliance 1b and necessary information to the terminal 1c. Here, the necessary information may include all pieces of information that are helpful to the user 1d in relation to the home appliance. The second server 2b may receive request information from the terminal 1c. Here the request information may be control information of the home appliance 1b, which is desired by the user.

The first server 2a may transmit the state information of the home appliance 1b to the second server 2b. The second server 2b may transmit the control information of the home appliance 1b to the first server 2a. The second server 2a may provide services to the user. Here, the service may include the operating of the home appliance in response to the user's needs.

The interaction between the server 2c, the home appliance 1b, the terminal 1c, and the user 1d will be briefly described.

The server may manage all of the home appliances that are the target of the service in order to perform the service. The home appliance may be connected to the server through the communication to execute commands transmitted from the server. The service request may be received by the server through the home appliance. The terminal may apply for the service request. The terminal may refer to devices having a communication module, such as mobile phones, smartphones, laptops, and computers. The terminal may communicate directly with the server. The server may communicate with the home appliance.

The home appliance may have a unique device ID. The ID may be registered and managed on the server. When the home appliance accesses the server, the server may specify the home appliance through the device ID. The server may manage characteristic information of the home appliance together with the device ID.

The home appliance may be fixed within the building. Stable communication with the server may be possible through an AP within the building. The terminal may communicate indirectly with the home appliance through the server.

The user may request and receive the service for the home appliance registered on the server through the home appliance. However, it may not be easy to request the service from the server through the home appliance. In this case, the service may be requested from the server through a device carried by the user such as the terminal. For this, an application program capable of implementing the service may be installed in the terminal.

The user may request service by accessing the server and inputting the unique device ID of the home appliance which wishes to receive the service. The user may be given a user ID and password. The user may log in to a site operating by the server and register all of own home appliances. The home appliances registered to the server may be registered to the server together with the corresponding user ID. This may be done by transmitting the user ID and the unique device ID of the home appliance matched with the user ID to the server through the site. The server may store user information related to the user and home appliance information related to the home appliance through the processes. The user information and the home appliance information may be matched and be stored on the server.

The user may register as a member of the site through an application installed on the terminal and be given a user ID and password. The user may recognize the application as an applicant's ThinQ app. The user may register all of their home appliances with the above application. The application may be provided for a remote service of at least one home appliance.

The user may request the service through the terminal and easily obtain information such as service performance and completion. The service processing process may include receiving the service request to the server through at least one of the site, the terminal, and the home appliance, processing the service request by the server, and executing a command for the corresponding service according to a processing code.

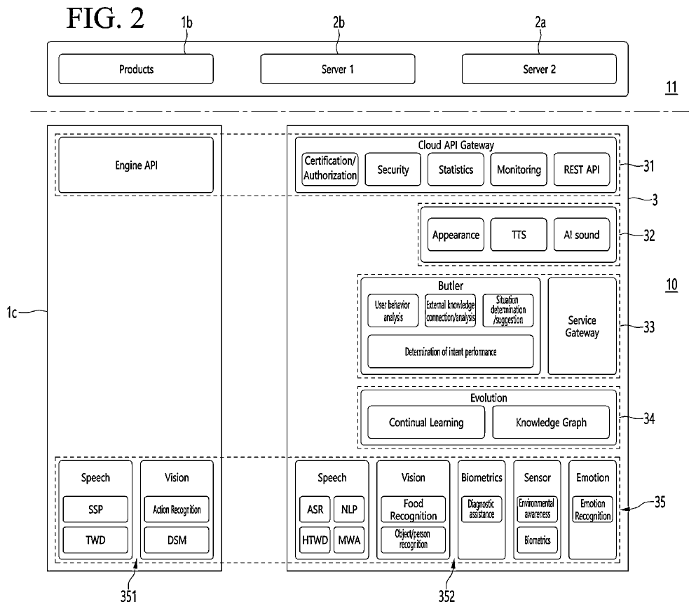

FIG. 2 is a view illustrating a configuration of the information processing system for the home appliance, which shows a cloud system in more detail.

Referring to FIG. 2, the information processing system according to the embodiment may be divided into an individual service area 10 and an application service area 11. In the individual service area 10, basic information for operating an information processing method, an information processing apparatus, and an information processing system according to an embodiment may be processed. The basic information may be first information for requesting an application service. For example, it may be the user's voice saying that he woke up. The voice may be basic information, and a service of the individual service area 10 may understand meaning of the voice. For example, this may be typical behavior after breakfast, behavioral patterns over a long period of time, or identifying user's movements over time. A variety of other basic information may be used.

The individual service area 10 may include at least one processor for an individual service. The application service area 11 may provide an application service to the user by applying the individual service supplied from the individual service area 10. The application service area 10 may include one or more processors for the application service. The processor may include hardware and software running on the hardware. The servers 2a and 2b may be implemented on a cloud system 3. The servers 2a and 2b may be implemented as one component of the cloud system, but for ease of understanding and differences in operation, the servers 2a and 2b may be displayed separately as illustrated in the drawing.

In the application service area 11, the home appliance 1b and the server 2c may be placed. The home appliance may include a plurality of devices already described. The server may communicate with the home appliance. The application service provided in the application service area may include a service directly requested by the user, a service indirectly requested by the user, a service that is considered requested by the user, and a service that is assumed to have been requested by the user. The application service may be determined by the server. The server may control the home appliance. The server may receive information about the home appliance. The server may communicate with the user through the terminal or home appliance.

The individual service area 10 may include a cloud system 3 and an edge device. The edge device may be a user's terminal 1c as an example. Here, the terminal may mean at least two terminals beyond a terminal of a single individual. The cloud system 3 may have large capacity and high-speed information processing capabilities. The cloud system may perform a heavy individual service 352 that requires a lot of resources to operate the service. The edge device may have small capacity and low-speed information processing capabilities. The edge device may provide a lightweight individual service 351 that requires a high-speed operation rather than accuracy.

The server 2c may initiate service in response to any one of several requests such as a request from the terminal 1c, a request from the home appliance 1b, and fulfillment of preset requirements.

If there is a request for the service, the server 2c may perform information processing corresponding to the requested service. The information processing may be performed by referring to information previously stored in a memory 40. The server may call at least one service of the individual service area 10 to perform the requested service. The server may use a combination of two or more services of the individual service area. The server may use the edge device for the individual service that requires rapid performance. The server may use the cloud system 3 for the individual service that requires accurate performance.

The performance result of the requested service may be in various forms, such as reporting to the user, controlling of the home appliance, and information storage. The performance result of the requested service may correspond to the requested service.

The performance process and result of the requested service may be notified to the terminal 1c and the home appliance 1b.

The plurality of individual services may be provided in the cloud system. The individual service may be performed by various service nodes such as virtual/physical machines, virtual/physical boxes, virtual/physical switches, and clusters in the cloud.

The individual service area may include an external management service 31 that manages the cloud and edge devices. The management service may include an interface. The management service may be provided to the cloud and edge devices. The individual service area may include an expression service 32 that provides a method of increasing in recognition corresponding to the user. The individual service area may include a butler service 33 that identifies the user's needs. The individual service area may include an awareness enhancement service 34 to improve performance of the butler service and the service. The individual service area may provide a recognition service 35.

Each of the above individual services will be described in more detail. The individual service may include various services that are presented below.

The management service 31 may include an application programming interface (API). The API may be a connection between computers or computer programs. The API may be a type of software interface and may provide the service to other types of software. The API may be applied to the edge device.

The management service 31 may include an API gateway. The API gateway may be a traffic manager that connects to an actual backend service or data and protects sensitive data by applying policies, authentication, and general access controls to API calls. The API gateway may perform authentication/authorization, security, statistics, and monitoring. A REST API may be an API that adheres to design principles of an REpresentational state transfer (REST) architectural style. The REST API may be said to comply with several principles applied in the cloud service.

The expression service 32 may include text-to-speech (TTS), i.e., voice synthesis. The TTS is a technology in which a machine automatically generates sound waves of speech sounds. For example, the TTS is a technology in which speech sounds of a person selected as a model are recorded, divided into certain speech units, and then coded and input into a speech synthesizer (speech computer, speech synthesizer). Then, only the necessary speech units are recombined according to instructions to create speed sounds artificially. The TTS may have various implementation methods.

The expression service 32 may include an AI sound. The AI sound refers to a technology that uses artificial intelligence (AI) to listen to sound and recognize a situation. For example, a scream or a sudden stop of a vehicle may be determined by listening to the sound.

The expression service 32 may include an appearance technology. An example of the facial expression technology is a technology that estimates feelings by looking at a face.

The butler service 33 may receive text, image information, sensor information, and situation information, which are the results of recognizing the user's voice input, as input data to determine the information based on a user's profile, context, and knowledge, thereby providing natural control and response. The butler service may use the recognition technology to analyze data received as input. The butler service may be linked to external services by determining the information as a knowledge base built on a knowledge management system (KMS). The butler service 33 may include user behavior analysis, external knowledge connection, external knowledge analysis, situation determination and response proposal, and intention execution determination.

The butler service 33 may provide control and response tailored to the conversation context and user situation by utilizing functions of the independently existing AI module. The user may feel customized services for themselves through the butler service 33.

The butler service 33 may include a service gateway that may access the external knowledge. The service gateway is a gateway for accessing the external services. The gateway may refer to a computer or software that enables communication between networks using different communication networks and protocols in the computer network. For example, the gateway may be a network point that acts as an entrance from one network to another network.

The recognition enhancement service 34 may include a learning processor. The cognitive enhancement service 34 may include continuous learning. The continuous learning is a method of upgrading one model little by little to enable to handle multiple tasks. In other words, the continuous learning is a method of improving model performance by continuously learning new data/tasks each time new learning is done, without forgetting previously learned data.

The recognition enhancement service 34 may include a knowledge graph. The knowledge graph may refer to a collection of interconnected descriptions of entities such as individuals, events, or concepts. The knowledge graph may store linking and semantic metadata within the context. This approach may provide a framework for data integration, unification, analysis, and sharing.

The recognition service 35 may include a speech service. The speech module may include various processors. The speech module may be used most accurately and conveniently by a remote user. The speech module has developed significantly compared to other modules.

The speech service may include a speech signal processing (SSP) service. The voice signal processing service is a function for applications such as voice communication and voice recognition. The sound source input to a microphone is of poor quality because of containing various noises from the surrounding area. Since low-quality sound sources are not used as is in voice calls or voice recognition programs, an SSP engine may be used to remove the noise and improve the quality of the sound source.

The speech may include a voice recognition (ASR: automatic speech recognition) service. The voice recognition service may provide a service that receives the user's voice data and converts the voice into text. The sound ‘slept well’ may be changed to the word ‘wake up’.

The speech may include a natural language processing (NLP) service. The natural language processing service may mean converting natural language, which is human language, into a semantic structure that machines may understand. The word ‘wake up’ may mean understood as waking up: waking up in the morning after going to bed.

The speech may include a hybrid trigger word detection (HTWD) service. The HTWD service may include firstly performing embedded-based startup word detection and secondly performing server-based startup word detection to minimize misrecognition of startup words.

The speech may include a trigger word detection (TWD) service. The TWD service may construct speech data sets and implement algorithms for trigger word detection (also known as keyword detection or wake word detection). The trigger word detection may allow devices such as Amazon Alexa, Google Home, Apple Siri, and Baidu DuerOS to hear a specific word and trigger the device to wake up. The TWD may mean performing maneuver word detection with a small capacity engine. For example, when a user says, ‘it was good sleep,’ the word ‘good sleep’ may be searched as a trigger word.

The speech may include a multi-device wakeup arbitration (MWA) service. The MWA service may be a service that selects the most appropriate device for the user when multiple devices recognize the same startup word at the same time. The MWA service measures the user's direction, distance, etc., selects the device that may best recognize the user's voice commands, and provides feedback to the user. For example, when the startup word is recognized for an air conditioner, a television, and an oven at the same time, a service for selecting a suitable device may be provided.

In the speech services, the speech signal processing (SSP) service and the trigger word detection (TWD) service may be included in the edge device 1c. Because the two services are lightweight, the services may fully run on the edge device's capacity. This is because the above two services are conveniently used for the purpose of the edge device.

The recognition service 35 may express a vision service. The vision service may include various sub-services. The vision service may correspond to services that a user may perceive with his/him eyes.

The vision service may include a food recognition service. The food recognition service may recognize a location of food stored in the refrigerator. For example, using an image of an egg, the user may photograph the egg and find out the location of the egg from the photographed image. The food recognition service may recognize food in various manners such as shape and barcode. The recognized foods may be managed on the server.

The vision service may include an object/person recognition service. The person/object recognition service may distinguish a target person/object using a two-dimensional and three-dimensional shape of an object. The classified information may be used for various purposes such as identification, movement, and recognition.

The vision service may include a driver state monitoring (DSM) service. The driver state detection service may detect the user's face from video image data, track gaze, and track eye closure and eye blinking to provide a location of the face, a head direction, facial feature points, gaze direction and angle, and a degree of eye closure. The driver state detection service may detect driver's drowsiness and issue a warning.

The vision service may include a behavior recognition service. The behavior recognition service may be a service that recognizes the user's behavior as an activation signal. For example, the behavior recognition service may be a service that starts the terminal by the user shaking the terminal. The DSM service and behavior recognition service may be implemented in the edge device.

The recognition service 35 may include a biometric service. The biometric service may be an example of any service that determines user's health information. For example, a diagnostic assistance service may be performed using heart rate, information, and sleep information transmitted using a smartwatch.

The recognition service 35 may include a sensor service. The sensor service may perform services such as recognizing environments and biometrics through the transmitted information.

The recognition service 35 may include an emotion service. The emotion service may include an emotion recognition (ER) service. The emotion recognition service is a service that recognizes emotions from the user's facial expression, voice, or text entered by the user. The ER services that recognize emotions enable natural verbal and non-verbal communication between the user and the machine to help the people and machines to communicate and interact smoothly with each other.

In the individual service area 10, various other services such as gait tracking and behavior prediction may be applied. Each of the service in the individual service area 10 may provide other services by linking one service with another service. The services of the edge device 1c may be equipped with services that require speed. The services of the individual service area 10 may be linked to other external networks.

The cloud system may be equipped with services that require accuracy and complexity. The edge device and the cloud system may cooperate with each other. For example, after starting up with the word recognized in the TWD of the edge device 1c, the cloud system 3 may accurately determine using the HTWD. As another example, the behavior recognition recognized in the vision service of the edge device 1c may be used as information for other purposes in the object/person recognition service of the cloud system 3.

Each service in the individual service area 10 may operate as a learning model of artificial intelligence. The recognition enhancement service 34 may be constructed as the learning model. For example, at least one of the expression service 32, the butler service 33, the recognition enhancement service 34, and the recognition service 35 may be provided as a learning model using artificial intelligence. Each service in the individual service area 10 may be implemented as a table or an operation formula constructed as a mathematical formula. Each service in the individual service area may contain a mixture of the learning model and calculation formulas using the artificial intelligence.

Each service in the individual service area 10, i.e., the service module may return the processing result of the service request to the application service area.

In all of the following embodiments, there may be no specific mention of the service module of the individual service area called by the application service area. In this case, all the individual service modules, which are capable of replying, may reply to the service request, corresponding to the nature of the call by the application service in the application service area. There may be specific reference to the service module of the individual service area called by the application service area. In this case, a preferred example is described, and it does not exclude that service modules in other individual service areas reply.

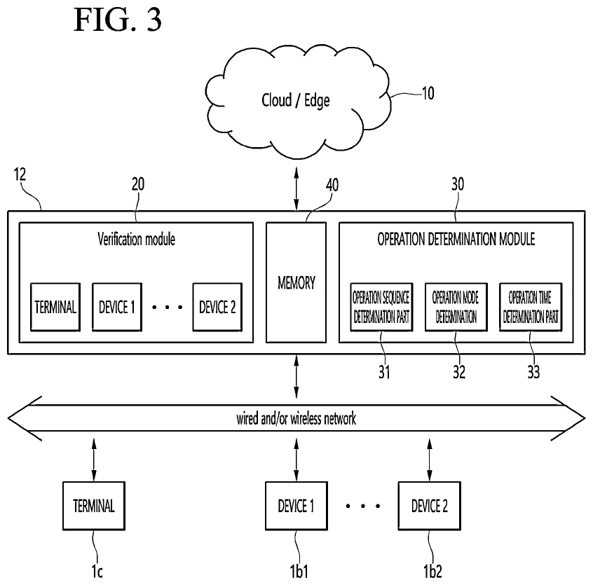

FIG. 3 is a view for explaining an information processing apparatus for the home appliance according to an embodiment.

Referring to FIG. 3, the information processing apparatus 12 according to an embodiment may include an I/O module 20 that confirms a status of each node, a memory 40 that stores information necessary for information processing, and an operation determination module 30 that determines an operation of each node in response to a situation confirmed by the I/O module. The node may include a home appliance and a terminal. The nodes do not exclude a terminal, a cloud system, and an edge device. A flow of information between the I/O module, the memory, and the operation determination module may be performed by an internal bus. The I/O module, the memory, and the operation determination module may share information with each other.

The information processing apparatus 12 may use an individual service of the individual service area 10. The information processing 12 apparatus may provide an application service. The information processing apparatus 12 may be a main processor that provides the application service. The information processing apparatus 12 may include a separate processor that provides the application service. The information processing apparatus 12 may be connected to the terminal 1c and the home appliances 1b1 and 1b2 through a wired or wireless network. The information processing apparatus 12 may be implemented by the server 2c.

The information processing apparatus 12 may start an operation by a trigger signal. The trigger signal may mean a starting signal. The trigger signal may be basic information. The basic information may be a simple signal that is not interpreted in itself. The trigger signal may be a direct or indirect signal from the user. For example, the trigger signal may be a user's voice message. In this case, the meaning may be understood after the voice message is processed into natural language. The individual service used at this time may be the natural language processing service described above.

The trigger signal may be a direct or indirect signal generated from each node connected to the home appliance. The trigger signal may be the fulfillment of a reserved condition. For example, when waking up in the morning is scheduled for 6 o'clock, it may be a signal from the clock that has reached 6 o'clock. As another example, it may be a user detection signal when automatically detecting the user.

The information processing apparatus 12 may request an individual service from the individual service area using the basic information. Here, the individual service may include understanding the meaning of the trigger signal, which is the basic information. Here, a speech service of the recognition service 35 may be used as the individual service. In the case of fulfillment of the reserved condition, the meaning has already been interpreted, and thus, understanding of the meaning may not be necessary even though it is the trigger signal.

The I/O module 20 may receive the trigger signal. The I/O module 20 may confirm each node in response to the trigger signal. The operating state of the home appliance may be known in response to the I/O module 20. The application service may include confirming the operation state of the home appliance. The above home appliance may be used by multiple people. The home appliance may have a reservation operation scheduled in advance. For example, the I/O module may determine information such as whether the home appliance is currently operating, waiting for operation, whether the operation has ended, and what specific contents of the operation standby state are. The information identified by the I/O module 20 may be stored in the I/O module for each home appliance.

With reference to the information identified by the I/O module 20, the operation determination module 30 may determine the operation E the home appliance. The application service may include determining the operation of the home appliance. The operation determination module may determine an operation in response to the trigger signal. The operation determination module may determine an operation corresponding to the user's service request.

The operation determination module may include an operation sequence determination part 31. The operation sequence determination part 31 may determine an operation sequence of at least two home appliances that interoperate with each other. Here, the operation sequence may be different from the operation sequence of the home appliance confirmed by the I/O. The operation determination module may include an operation mode determination part 31. The operation mode determination part 31 may determine an operation mode of at least one home appliance. Here, the operation mode may be different from the operation mode of the home appliance confirmed by the I/O. The operation determination module may include an operation time determination part 33. The operation time determination part 33 may determine an operation time of at least one home appliance. Here, the operation time may be different from the operation time of the home appliance confirmed by the I/O.

The operation determination module 30 may operate with artificial intelligence. The operation determination module 30 may operate using the individual service of the individual service area 10. For example, it may operate using the learning model of the recognition enhancement service 34.

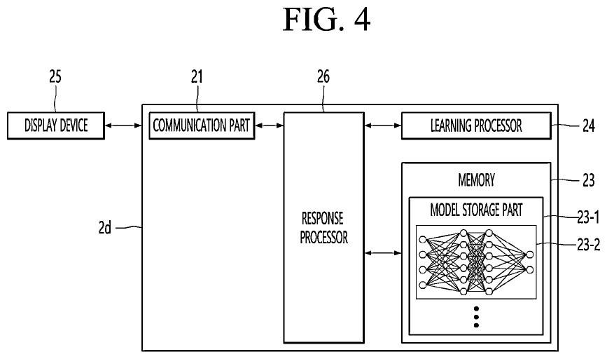

FIG. 4 is a view for explaining an example of providing the learning model.

Referring to FIG. 4, an artificial intelligence (AI) server 2d may refer to a device that learns an artificial neural network by using a machine learning algorithm or uses a learned artificial neural network. The AI server 2d may include a plurality of servers to perform distributed processing, or may be defined as a 5G network. In this case, the AI server 2d may be included as a partial configuration of the display device 25, and may perform at least part of the AI processing together. The AI server 2d may be a portion of the server 2c.

The AI server 2d may include a communication part 21, a memory 23, a learning processor 24, and a response processor 26. The communication part 21 may transmit and receive data to and from an external device such as the display device 25.

The memory 23 may include a model storage part 23-1. The model storage part 23-1 may store a learning or learned model (or an artificial neural network 23-2) through the learning processor 24.

The learning processor 24 may learn the artificial neural network 23-2 by using the learning data. The learning model may be used in a state of being mounted on the AI server 2d of the artificial neural network, or may be used in a state of being mounted on an external device such as the display device 25.

The learning model may be implemented in hardware, software, or a combination of hardware and software. If all or part of the learning models are implemented in software, one or more instructions that constitute the learning model may be stored in memory 63.

The response processor 26 may infer the result value for new input data by using the learning model and may generate a response or a control command based on the inferred result value.

The learning model implemented by the AI server may be provided for each service provided in the individual service area. Each learning model may provide a response for each service. The operation determination module 30 may receive a response using each learning model.

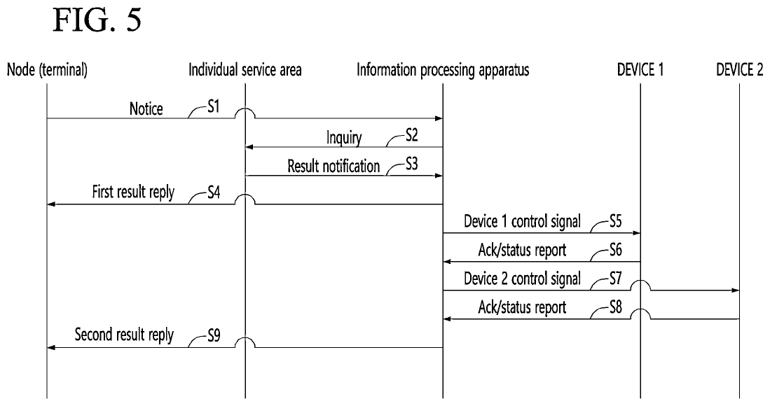

FIG. 5 is a view illustrating a flow of an information processing method according to an embodiment.

Referring to FIG. 5, the information processing apparatus 12 may receive the trigger signal from the node (S1). The node may be a terminal or a home appliance. The information processing apparatus may request an individual service from the individual service area (S2). Here, the individual service may include understanding the meaning of the trigger signal. For example, the speech service of the recognition service 35 may be used.

The individual service area may perform result notification as a result of responding to the request of the information processing apparatus (S3). The result notification may include at least one of the meaning of the trigger signal, a list of necessary operations corresponding to the trigger signal, or a list of operations required for the node.

The information processing apparatus may perform functions such as selecting a required operation of the home appliance in response to the trigger signal, and selecting an operation required by the user in response to the trigger signal. The information processing apparatus may provide an application service. The information processing apparatus may notify the node of the meaning of the trigger signal, the necessary operation corresponding to the trigger signal, the operation required from the node, and the confirmation result as a first result reply (S4).

The information processing apparatus may transmit a first control signal to the first home appliance (S5). The first home appliance may transmit an ack signal and a status report signal including the execution result of the first control signal (S6). The information processing apparatus may transmit a second control signal to the second home appliance (S7). The second home appliance may transmit an ack signal and a status report signal including the execution result of the second control signal (S8).

The information processing apparatus may notify the node of the performance results of the first and second home appliances as a second result reply to the node (S9). The node may include more home appliances in addition to the first and second home appliances. The node may include any one of the first and second home appliances. At least one process of the information processing method may be omitted in the information processing method according to another embodiment. At least one process of the information processing method according to another embodiment may be added to the information processing method.

An information processing method for the home appliance according to an embodiment will be described.

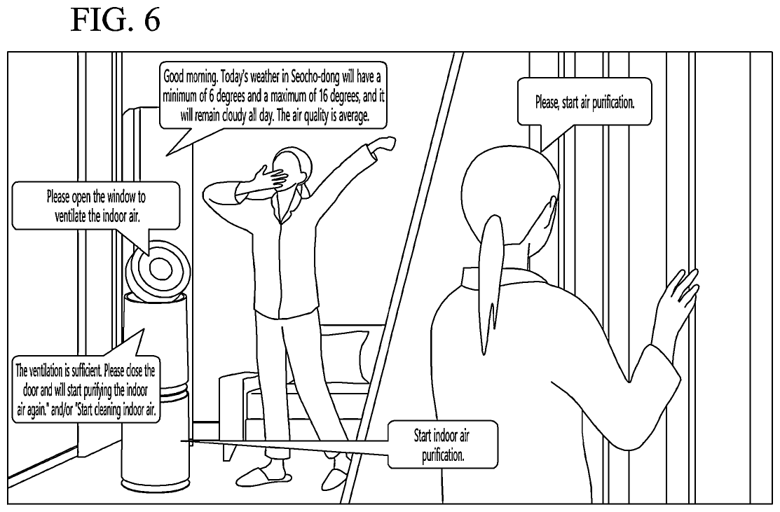

FIG. 6 is a view illustrating an interface in the information processing method according to an embodiment. Terms used in the interface in the drawings are directly quoted from the description of the embodiment for convenience of understanding. Other terms and methods with similar meaning may be used.

FIG. 6 illustrates user' waking up in the morning.

Referring to FIG. 6, a user 1d may transmit what happened to him. The trigger signal may be an action after waking up. A transmission method to the effect of waking up may exemplify action. In addition, it may be transmitted to the information processing apparatus 10 in various manners such as text messages, verbal messages, agreed upon actions, and typical actions. This process may correspond to the notification process (S1) in FIG. 5.

The user's message may be understood as meaning that the user's woke up. The effect of the user's wake up may be interpreted by at least one service of the recognition service 35, the butler service 33, or the recognition enhancement service 34 provided as the service in the individual service area 10. The interpreted results may include the effect that the user has woken up and the actions that the home appliance should take in response to the user going out. This process may correspond to an inquiry process (S2) and a result notification process (S3) in FIG. 5.

In response to the interpreted results, the information processing apparatus may provide a reply to the user in the form of a language message and an illumination message. For example, the interpreted results may be transmitted to the home appliance. The home appliance that has received this message can reply to the user with “wake up” At least one home appliance may be provided. Each of the home appliances may transmit its own message.

The user 1d who received the reply may confirm that the information processing system has operated correctly. This process may correspond to the first result replay process (S4) of FIG. 5.

In response to the interpreted results, the information processing apparatus may determine the current state of the home appliance by transmitting the control signal to the device. The home appliance may transmit an ack/status report in response to the control signal. This process may correspond to the control signal and ack/status report (S5 to S8) of FIG. 5. If there is information that the user should pay attention to in the ack/status report (S6) (S8) of the home appliance, the second result reply process (S9) of FIG. 5 may be performed. For example, if there is no signal because the home appliance is not operating normally, the effect may be transmitted as a second result reply. The second result reply may be omitted.

In response to the interpreted results, the information processing apparatus may provide an application service. The information processing apparatus may determine a control signal for performing the application service. The information processing apparatus may transmit and control the control signal to the home appliance. In this case, it may be a case that the ack/status report (S6) (S8) of the home appliance has been performed normally. The application service may include at least one of an operation sequence, an operation mode, or an operation time of the home appliance.

In response to the analyzed result, the information processing apparatus may determine at least one of the operation sequence, the operation mode, or the operation time of at least one home appliance. The information processing apparatus may control the home appliance using at least one of the determined operation sequence, operation mode, or operation time. The information processing apparatus may control the home appliance to notify the user of the results. This process may be called a third result reply.

Examples of each reply in the third result reply are provided. The information processing device may instruct that “Good morning. The weather in Seocho-dong today is a minimum of 6 degrees and a maximum of 16 degrees and will remain cloudy all day. The air quality is average.” and/or “Please open the window to ventilate the indoor air.” to the air purifier. The air purifier may transmit a voice message to the user.

The third result reply may allow the user to open the window so as to perform the ventilation. The ventilation message may be linked to an operation that automatically operates the ventilation device.

According to the third result reply, the user may operate the air purifier, but as a more desirable alternative, the ventilation may be performed.

After the ventilation is finished, say, “The ventilation is sufficient. Please close the door and will start purifying the indoor air again.” and/or “Start cleaning indoor air.” Here, according to the third result reply, the air purifier may operate like the message. The third result reply may be called a second result reply. Here, the end of the ventilation may be triggered by the user's action of closing the door and sufficient ventilation when measuring air quality.

Even before the ventilation is ended, the user may give the instruction while closing the door. For example, as the user closes the door, the trigger signal may be transmitted, like, “Start air purification.” In this case, the user may instruct “Start indoor air purification.” Here, according to the third result reply, the air purifier may operate like the message. This third result reply may be said to be a third result reply.

As seen in the above process, the third result reply may include two messages following in time series order. The third result reply may include two messages that are not connected in time series. For example, the second third result reply and the third result reply may not be followed in time series order.

In the information processing method, the information processing apparatus may determine outdoor environment information, weather information, outdoor air quality information, indoor environment information, and indoor air quality information. The information processing apparatus may use the identified information to determine when air purification is necessary. Here, the information processing apparatus may use an individual service in an individual service area. Here, the memory may store the information. The memory may acquire and store the information in advance through a network.

The third result reply may be transmitted through a terminal. Alternatively, in the third result reply, the corresponding home appliance may transmit the message. This is because the user who wakes up in the morning is at home. The message may be transmitted directly to the user. The message may be of various types, such as a stored voice, an alarm, and a stored sign.

The third result reply process may have more diverse cases depending on the information processing method of the home appliance. The user may know that the application service has been properly performed through the third result reply.

Hereinafter, various embodiments of information processing methods for the home appliance will be described. An example of the home appliance may be an air purifier. The air purifier may be operated in various manners depending on a built-in filter. Typically, there is a dust filter. Dusts that are capable of being filtered by a filter may vary depending on fineness of the filter. There is a filter that filters a secondary gases such as an organic compound. There is a third gas that is not filtered by the filter. An example of the third gas is carbon dioxide. The filter that filters carbon dioxide is difficult to install in a general air purifier. It is desirable to ventilate indoor air with gases such as carbon dioxide.

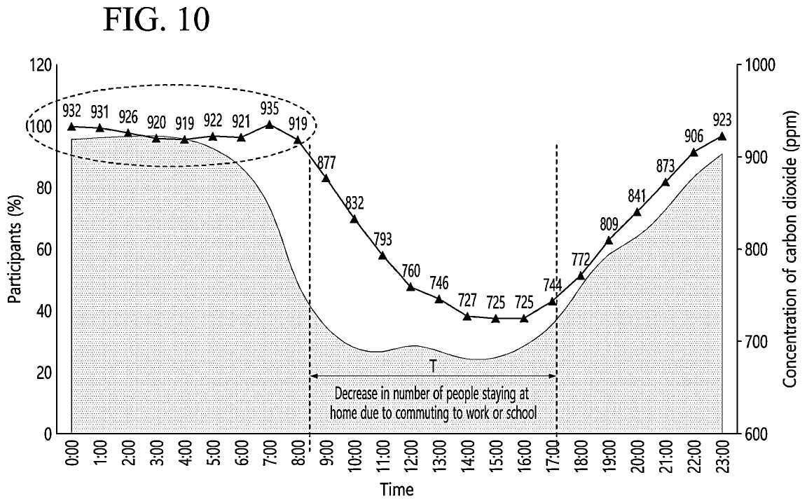

While ventilating the third gas, fine dust may be introduced. The inflow of the fine dust during the ventilation of carbon dioxide may be inconvenient for users. Referring to FIG. 10, it is seen that carbon dioxide shows a high density from evening to morning, and thus, the ventilation is necessary. For example, carbon dioxide peaks at 935 ppm at 7 am.

In addition to this, operating of one home appliance may be advantageous in one respect but disadvantageous in another respect. As another example, when a robot vacuum cleaner operate, the indoor floor is clean, but fine dust may be floated in indoor space. It may be preferable that the air purifier operates to remove the floating dust. There may be many other cases.

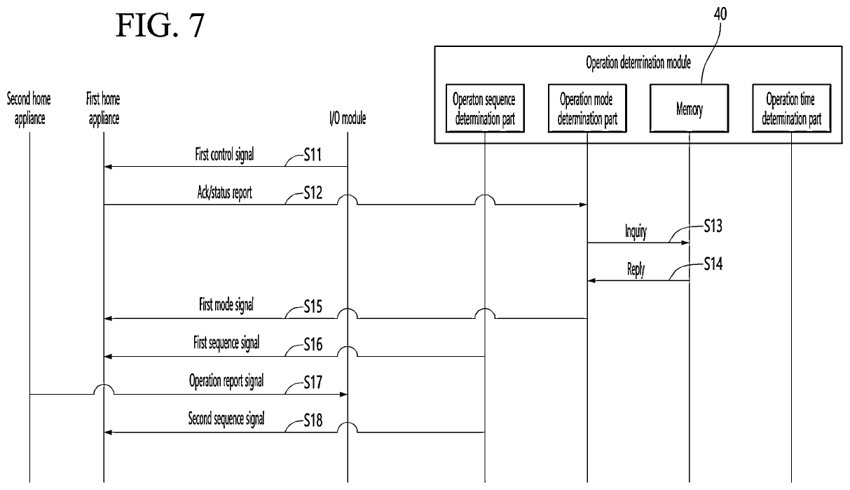

FIG. 7 is a flowchart of the information processing method for the home appliance according to an embodiment. This embodiment may be an embodiment after the user's waking up or the current indoor environment is identified as environmental information requiring the air purification. Here, the air purification may include both ventilation and air filtering. For example, it may be an information processing method after the information processing method of FIG. 5 determines what the user is woken up (S3).

Referring to FIG. 7, the I/O module 20 may determine the current state of the home appliance 1b by transmitting the first control signal to the home appliance 1b (S11). The home appliance may transmit an ack message and a status report message (S12). The home appliance may transmit the ack message and the status report signal to at least one of the I/O module 20 pr the operation determination module 30. Through the bus inside the information processing apparatus, each module of the information processing apparatus may share information. The ACK message may be transmitted to the I/O module. The status report message may be transmitted to the operation determination module.

The operation mode determination part 32 may receive the status report message. The operation mode determination part may determine the operation mode of the home appliance by referring to the status report message. Depending on the type of the home appliance and/or the status report message, the operation mode of the home appliance may be determined differently.

The information processing method will be explained with an example.

In the case in which the air purifier is the first home appliance, the status report message may inform the current stopped or operating status. The operation mode determination part may inquire about necessary information from the memory 40 (S13) and receive a reply (S14). Here, necessary information may include outdoor environment information, weather information, outdoor air quality information, and indoor air quality information. The indoor air quality information may also be obtained through the status report message from the air purifier.

The operation mode determination part may determine that it is currently preferable to operate the ventilation device rather than operate the air purifier. The case in which the ventilation is desirable are described above.

The operation mode determination part may transmit a first sequence signal instructing the first home appliance to maintain an operation of the first home appliance (S16). Here, standby may mean maintaining the operation of the first home appliance without change. If the air purifier is operating according to a first order signal, the operation may be continued. If the air purifier is stopped according to the first order signal, the stopped state may be maintained. The operation mode determination part may instruct the first home appliance to output a message (S15). For example, a message such as “Good morning. The weather in Seocho-dong today is a minimum of 6 degrees and a maximum of 16 degrees and will remain cloudy all day. The air quality is average.” and/or “Please open the window to ventilate the indoor air.” may be transmitted to the air purifier. The first home appliance may be a terminal. In this case, the user may hear instructions directly from the terminal. Thereafter, the user may directly open the window.

The user's action of opening the window may be known as a motion report signal (S16). Due to the operation report signal, basic information related to a case in which the user opens the window, a user's voice may be interpreted through the individual service, a reduction in concentration of carbon dioxide may be detected by an air quality sensor according to the ventilation, and a voice signal that informs an opening of the window may be interpreted through the individual service.

It may be a home with a ventilation device. In this case, a message such as “Good morning. Today's weather in Seocho-dong will have a minimum of 6 degrees and a maximum of 16 degrees, and it will remain cloudy all day. The air quality is average.” and “Turn on the ventilation device to ventilate the indoor air.” may be transmitted as an example. The ventilator may transmit the message directly, or the terminal may transmit the message directly. In this case, the operation report signal may be an operation start signal of the ventilation device.

After the operation report signal, the operation sequence determination part may transmit a second sequence signal (S18). If the air purifier is in operating according to the second sequence signal, the operation may be stopped. If the air purifier is stopped according to the second sequence signal, the stopped state may be maintained. According to the first sequence signal, the current operating state of the air purifier may be maintained without determining the operating state. According to the second sequence signal, the operating state of the air purifier may be stopped.

An action of the operation sequence determination part may be performed by the operation time determination part. For example, in an environment where a more accurate operation time is important, the operation time determination part may operate along with or instead of determining the operation sequence. The operation time determination part may determine the operation time of at least one home appliance. The operation time of the at least one home appliance may be different. The operation time of the at least one home appliance may be the same.

After the second sequence signal transmission step (S18), there may be an operation report signal again. For example, it may be a state in which the ventilation device is stopped, or an operation in which the user closes the window. In this case, the air purifier that has stopped may operate again according to the second sequence signal. Accordingly, fine dust introduced during ventilation may be further removed.

Through this control method for the home appliances, the user may use the home appliances more conveniently, safely and be saved in energy. If the cooperative operation is performed between the air purifier and the ventilation device or between the air purifier and the user tracking camera, air purification may be efficient.

The control method for this construction device may only be performed during certain time periods. For example, it may only be conducted between 5 am and 10 am. In other words, it may be performed at a time when the user starts to wake up after going to bed.

The control method for this household appliance may be performed without notifying the user, except for transmitting the message to the user. Through this control method for home appliances, the user may use the home appliances in a control method that is beneficial to their health without the user being aware of it.

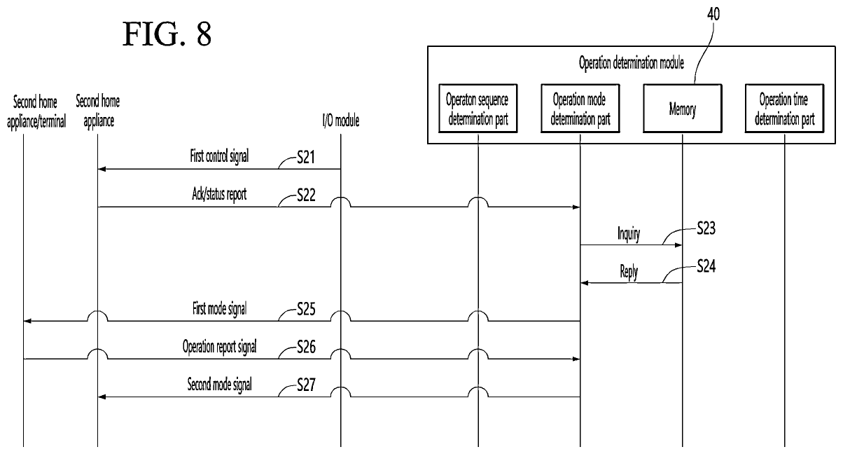

FIG. 8 is a flowchart of the information processing method for the home appliance according to an embodiment. This embodiment may be an embodiment after the user's intention to operate the air purifier is identified. For example, it may be an information processing method after the purpose of operating the air purifier (S3) is identified by the information processing method of FIG. 5.

Referring to FIG. 8, the I/O module 20 may determine the current state of the appliance by transmitting the first control signal to the home appliance 1b (S21). The home appliance may transmit an ack message and a status report message (S22). The home appliance may transmit the ack message and the status report signal to at least one of the I/O module 20 and the operation determination module 30. Through the bus inside the information processing apparatus, each module of the information processing apparatus may share information. The ACK message may be transmitted to the I/O module. The status report message may be transmitted to the operation determination module.

The operation mode determination part 32 may receive the status report message. The operation mode determination part may determine the operation mode of the home appliance by referring to the status report message. Depending on the type of the home appliance and/or the status report message, the operation mode of the home appliance may be determined differently.

The information processing method will be explained with an example.

In the case in which the air purifier is the first home appliance, the status report message may inform the current stopped or operating status. Here, the second home appliance, which is the ventilation device or a window status detection device, may be in a state in which the ventilation is being performed. The operation mode determination part may inquire about necessary information from the memory 40 (S23) and receive a reply (S24). Here, necessary information may include outdoor environment information, outdoor air quality information, and indoor air quality information. The indoor air quality information may also be obtained through the status report message from the air purifier.

The operation mode determination part may currently determine that it is desirable to stop the ventilation device before operating the air purifier. The operation mode determination part may currently determine that it is desirable to close the window before operating the air purifier. For example, the second gas may have been sufficiently exchanged, but as a result, at least one of dust and the first gas may be introduced into the indoor space in large quantities. As a result, the air purifier may operate, but the ventilation may be stopped.

The case in which the air purification is desirable are described above.

The operation mode determination part may transmit a first mode signal instructing the second home appliance to stop the operation of the second home appliance (S25). Here, the second home appliance may be the ventilator. The ventilation device may be stopped according to the first mode signal. As another method, a message may be transmitted according to the first mode signal to instruct the user to close the window.

If there is an operation report signal that changes the ventilation state (S26), the air purifier may operate by transmitting a second mode signal (S26).

Through this control method for home appliances, the user may use the home appliances in a control method that is beneficial to their health without the user being aware of it.

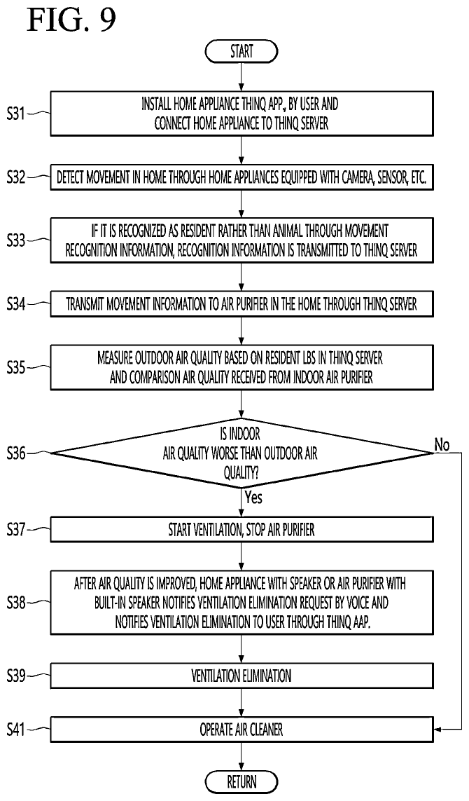

FIG. 9 is a flowchart of the information processing method for the home appliance according to an embodiment. In this embodiment, a view for explaining an information processing method for a plurality of home appliances is illustrated.

Referring to FIG. 9, an application program is installed on the user's home appliance, and the home appliance may be connected to a server through a network (S31). As an example, the application may be a ThinQ app. The application program may be installed by the server 2c. In this state, the user's wake up may be identified, and the air purification may be expected (S32). Here, what is expected from the air purifier may be understood as various information that refers to the user's wake up. For example, various initial information such as the terminal's wake-up alarm, the user's characteristic voice, and the user's behavior may be used. The meaning of initial information may be understood by utilizing each individual service in the individual service area. In the drawing, the user's movement is presented as the most desirable example. Here, movement in home may not be that of a person, but of a companion animal. Distinguishing between the companion animal and the user may be done through a recognition service of the individual service. Accordingly, if it is determined that the user is, the information may be transmitted to the server (S33), and the server may check at least one home appliance (S34). For example, the user may check the air purifier.

The server may transmit a predetermined control command to the home appliance (S35). The control command may be information that the user has woken up and a call for a corresponding action of the home appliance. The server may compare air quality by comparing the indoor environment with the outdoor environment (S35)

Compare indoor with outdoor air quality, and as a result (S36), an outdoor air quality may be poor. In this case, the air purifier may operate (S41). Here, an indoor air quality may be obtained with a built-in sensor of the air purifier. The outdoor air quality may be obtained from a networked database.

Compare indoor with outdoor air quality and as a result (S36), the indoor air quality may be poor. Here, the ventilation may be started (S37). Starting of the ventilation may be performed by ventilation of an automatic ventilation device, a message transmitted to the user, and ventilation guidance to the user through at least one home appliance. In morning wake-up conditions, the ventilation may be strongly required due to the high concentration of carbon dioxide. The air purifier may be stopped when the ventilation starts (S37).

After the predetermined time required for the ventilation has elapsed, the ventilation may no longer be needed. Here, the user may be notified that the ventilation is no longer necessary (S38), and the ventilation may be terminated (S39). Here, an ending of the ventilation may be performed through a process of allow the user to close directly the window through the automatic ventilation device and the message.

Thereafter, dust introduced into the indoor space during the ventilation and the second gas may be purified. The air purifier may operate to purify the dust and the second gas (S41). The air purifier may restart in a stopped state. If the air purifier operates while the ventilation is being performed, it may not be desirable because of reducing the lifespan of the filter.

### INDUSTRIAL APPLICABILITY

According to the present invention, it is possible to activate the consumption of the remote control function of the home appliances.

According to the present invention, there may be the advantage to the user because the home appliance is used in a manner that is advantageous to the user even without the user being aware of it.

1. An information processing system, comprising:
a plurality of home appliances;
a terminal configured to process information of the plurality of home appliances;
an individual service area configured to provide an individual service; and
an information processing apparatus connected to the terminal and the plurality of home appliances through a network and configured to provide an application service using the individual service,
wherein the information processing apparatus is configured to:
receive basic information of a user using the plurality of home appliances;
confirm that environmental information of an indoor environment needs air purification from the basic information by using the individual service;
confirm a first state of a first home appliance of the plurality of home appliances; and
maintain the first home appliance in the first state in response to the environmental information, and either change a state of a second home appliance of the plurality of home appliances in response to the environmental information, or transmit a message to the user in response to the environmental information.

2. The information processing system according to claim 1, wherein the basic information comprises at least one of the user's behavior, the user's voice, or detection information of an air quality sensor.

3. The information processing system according to claim 1, wherein the first home appliance is an air purifier,
wherein the first state is a state in which the air purifier is in an operating state or a non-operating state, and
wherein the second home appliance is a ventilation device.

4. The information processing system according to claim 3, wherein the ventilation device starts in a non-operating state, and
wherein, when a state of the ventilation device being in the non-operating state changes, the ventilation device is configured to switch to an operating state.

5. The information processing system according to claim 1, wherein, after a state of the second home appliance is changed, the first home appliance is in a non-operating state.

6. The information processing system according to claim 5, wherein the first home appliance is an air purifier, and
wherein the second home appliance is a ventilation device.

7. The information processing system according to claim 6, wherein when the ventilation device is changed to an operating state,
the air purifier is switched to the non-operating state, or the message transmitted to the user is a message to start ventilation of the indoor environment.

8. The information processing system according to claim 1, wherein the first home appliance is an air purifier,
wherein the first state is a non-operating state of the air purifier,
wherein the basic information is an operation start signal of the air purifier, and
wherein the second home appliance is a ventilation device.

9. The information processing system according to claim 8, wherein the message transmitted to the user is a message to stop a ventilation of the indoor environment.

10. An information processing apparatus, comprising:
an input/output (I/O) module configured to communicate with a plurality of home appliances;
a memory configured to store outdoor environment information; and
an operation determination module configured to:
compare indoor environment information, in which a user using the plurality of home appliances resides, with the outdoor environment information to confirm that air purification is necessary,
maintain a first home appliance of the plurality of home appliances in a first state being a current state of the first home appliance, and either change a state of a second home appliance of the plurality of home appliances or transmit a message related to the air purification to the user.

11. The information processing apparatus according to claim 10, wherein, after the state of the second home appliance is changed, the state of the first home appliance is changed from the first state to a second state, and
wherein the first state is one of an operating state or a non-operating state, and the second state is the other of the operating state or the non-operating state.

12. An information processing method for a home appliance, comprising:
receiving a user's basic information;
allowing an information processing apparatus to identify air purification information from the basic information using an individual service in an individual service area;
comparing indoor environmental information with outdoor environmental information; and
performing either (i) a first process of operating a ventilation device in an operating state after maintaining a state of an air purifier to purify air or (ii) a second process of operating the air purifier in a state in which the ventilation device is stopped to purify the air,
wherein the first process is performed when a value of the outdoor environmental information is higher than a value of the indoor environmental information, and
wherein the second process is performed when the value of the outdoor environmental information is lower than the value of the indoor environmental information.

13. The information processing method according to claim 12, wherein the basic information is the user's action at a predetermined time.

14. The information processing method according to claim 12, wherein, when the ventilation device operates in the operating state, the air purifier is in a non-operating state.

15. The information processing method according to claim 12, wherein, after completion of the operating state, the ventilation device switches to a non-operating state, and the air purifier switches to an operating state.

16. The information processing method according to claim 12, wherein the indoor environment information and the outdoor environment information contain information on a concentration of carbon dioxide.

17. The information processing method according to claim 12, wherein the individual service operates by an artificial intelligence (AI) server.

18. The information processing method according to claim 12, wherein the first process or the second process is performed without notifying the user.

19. An information processing method, comprising:
receiving a user's basic information;
allowing an information processing apparatus to identify air purification information from the basic information using an individual service in an individual service area; and
either operating a ventilation device in an operating state after maintaining a state of an air purifier configured to purify air, or transmitting a message to the user,
wherein the operating the ventilation device in the operating state is performed when a value of the air purification information is lower than a threshold value.

20. The information processing method according to claim 19, wherein, when the ventilation device is in the operating state, the air purifier is in a non-operating state, and
wherein after the ventilation device operates in the operating state for a predetermined time, the air purifier switches to an operating state.
